(19) United States
(12) Patent Application Publication
(10) Pub. No.: US 2025/0350376 A1
(43) Pub. Date: Nov. 13, 2025

(54) COUNTER-ROTATING BLADE-TYPE UNDERWATER LOW-FREQUENCY SOUND-EMITTING DEVICE

(71) Applicant: HUNAN UNIVERSITY OF SCIENCE AND TECHNOLOGY, Xiangtan (CN)

(72) Inventors: Yongping JIN, Xiangtan (CN); Shuli LIU, Xiangtan (CN); Buyan WAN, Xiangtan (CN)

(21) Appl. No.: 19/277,221

(22) Filed: Jul. 22, 2025

(51) Int. Cl. H04B 11/00

(52) U.S. Cl. CPC H04B 11/00

(57) ABSTRACT

A counter-rotating blade-type underwater low-frequency sound-emitting device includes a counter-rotating blade assembly, a first driving assembly, a second driving assembly and an oscillation converting assembly. The counter-rotating blade assembly includes a main shaft, a primary blade assembly mounted on the main shaft, a hub shaft sleeved on the main shaft, a secondary blade assembly mounted on the main shaft, and a counter-rotating conversion assembly. Two ends of the primary blade assembly are respectively connected to the hub shaft and the secondary blade assembly. The secondary blade assembly and the primary blade assembly have opposite rotating directions. The first driving assembly is configured to drive the hub shaft to rotate. The second driving assembly is configured to drive the main shaft to do linear reciprocation and convert it to periodic reciprocating oscillation of blades of the secondary blade assembly.

### TECHNICAL FIELD

This application relates to underwater sound-emitting devices, and more particularly to a counter-rotating blade-type underwater low-frequency sound-emitting device.

### BACKGROUND

Acoustic wave is recognized as the only carrier for the long-range information transmission in the ocean, and thus plays a crucial role in the exploration, development and utilization of the ocean. In recent years, extensive attempts have been made to develop low-frequency, high-power and small-sized underwater acoustic source systems. The existing underwater sound sources can be categorized into three main types: electroacoustic, explosive, and hydrodynamic sound generation. The electroacoustic generation is the most widely used acoustic wave generation method, which utilizes a variety of transducers to convert electrical energy into acoustic energy. However, a high-power power supply system is necessary for the electroacoustic generation to generate a high-power and intensity acoustic output, resulting in large volume and weight, high energy consumption and low energy conversion efficiency. Moreover, it is difficult to break through the source level in the low-frequency emission. The acoustic wave generated by the explosive sound generation is generally a transient and multi-frequency mixing noise, which is difficult to control and sustain. The hydrodynamic source has a simple structure and high reliability, offering significant advantages in the low-frequency and high-power emission. However, it has been rarely reported about the hydrodynamic source so far. Especially for the rotating-blade modulated acoustic source, no mature equipment has been developed for the underwater application. Therefore, it is urgent to develop a blade-type underwater low-frequency sound-emitting device to study underwater sound radiation characteristics of the rotating-blade modulated acoustic source, and to provide data support for subsequent development of the rotating-blade underwater sound generation device with low frequency, large power and small size.

### SUMMARY

In order to solve the above problems, this application provides a counter-rotating blade-type underwater low-frequency sound-emitting device, which has simple structure, reliable function, high efficiency and balance torque, and can independently adjust counter-rotating motion parameters and oscillation parameters of the blades to modulate low-frequency acoustic waves with different characteristics.

Technical solutions of this application are described as follows.

A counter-rotating blade-type underwater low-frequency sound-emitting device is provided, comprising:
a counter-rotating blade assembly;
a first driving assembly;
a second driving assembly; and
an oscillation converting assembly;
wherein the counter-rotating blade assembly comprises a main shaft, a primary blade assembly, a hub shaft, a secondary blade assembly and a counter-rotating conversion assembly; the primary blade assembly is mounted on the main shaft through a first bearing, and comprises a plurality of first blades; the secondary blade assembly is mounted on the main shaft, and comprises a plurality of second blades; the hub shaft is sleevedly provided on the main shaft; a first end of the primary blade assembly is connected with the hub shaft, and a second end of the primary blade assembly is connected with the secondary blade assembly through the counter-rotating conversion assembly; the counter-rotating conversion assembly is configured to reverse and transmit rotation of the primary blade assembly to the secondary blade assembly; and a rotating direction of the secondary blade assembly is opposite to that of the primary blade assembly;
the first driving assembly is configured to drive the hub shaft to rotate; and
the second driving assembly is configured to drive the main shaft to perform linear reciprocation; and the oscillation converting assembly is configured to convert the linear reciprocation of the main shaft into periodic reciprocating of the secondary blade assembly.

In an embodiment, the primary blade assembly further comprises a plurality of first blade bases and a first hub;
wherein a first end of the first hub is connected with the hub shaft, and a second end of the first hub is connected with the counter-rotating conversion assembly; the hub shaft has a tubular structure; and the hub shaft is connected with the first driving assembly;
the first hub has a cylindrical structure with a center hole; the center hole of the first hub has a first polygonal cross section, and the number of sides of the first polygonal cross section is a multiple of the number of the plurality of first blades; the first bearing has a sliding bearing structure, and the first bearing is in transition fit with the center hole of the first hub; each side of the center hole is provided with a first base hole; the first base hole is a cylindrical stepped hole with a round cross section, and a diameter of an end of the first base hole close to the plurality of first blades is smaller than that of an end of the first base hole away from the plurality of first blades; each of the plurality of first blade bases has a stepped shaft structure, and the first base hole is in clearance fit with a corresponding one among the plurality of first blade bases; and the plurality of first blades are fixedly provided on outer end surfaces of the plurality of first blade bases, respectively.

In an embodiment, the secondary blade assembly further comprises a plurality of second blade bases, a second hub and a front end cover;
wherein a first end of the second hub is connected with the counter-rotating conversion assembly, and a second end of the second hub is connected with the front end cover; the secondary blade assembly and the primary blade assembly are coaxial, and have opposite mounting angles; and
the second hub has a cylindrical structure with a center hole; the center hole of the second hub has a second polygonal cross section, and the number of sides of the second polygonal cross section is a multiple of the number of the plurality of second blades; each side of the center hole is provided with a second base hole; the second base hole is a cylindrical stepped hole with a round cross section; a diameter of an end of the second base hole close to the plurality of second blades is smaller than that of an end of the second base hole away from the plurality of second blades; the second base hole is in clearance fit with a corresponding one among the plurality of second blade bases the plurality of second blades are fixedly provided on outer end surfaces of the plurality of second blade bases, respectively; and the second hub is provided on an end of the main shaft, and the main shaft is in clearance fit with the center hole.

In an embodiment, the counter-rotating conversion assembly comprises a first gear, a plurality of second gears, a gear ring and a connecting plate;
wherein the first gear comprises a connecting part and a gear part, and the connecting part and the gear part are coaxially provided; an end of the connecting part is coaxially connected with the first hub; the gear part engages with the plurality of second gears, and the plurality of second gears engage with the gear ring; the gear part and the plurality of second gears are provided in the gear ring, and the plurality of second gears are provided between the gear part and the gear ring; and
the connecting plate is fixedly provided at an end of the gear ring adjacent to the secondary blade assembly, and is connected with the second hub.

In an embodiment, the first driving assembly comprises a first motor, a motor shaft and a motor shell;
wherein a stator of the first motor is fixedly provided on an inner wall of the motor shell; a rotor of the first motor is fixedly connected with the motor shaft; the motor shaft has a tubular structure; an end of the motor shaft adjacent to the counter-rotating blade assembly is provided with a first flange; the hub shaft is provided with a second flange; and the first flange is connected with the second flange to drive the counter-rotating blade assembly to rotate.

In an embodiment, the second driving assembly comprises a second motor, a coupling, a crank shaft, a connecting rod, a piston rod and a bearing assembly;
wherein an output shaft of the second motor is perpendicular to an axis of the main shaft, and is coaxially connected with an end of the crank shaft through the coupling; two ends of the crank shaft are coaxial, and an axis of a middle part of the crank shaft is parallel to the output shaft of the second motor; a first end of the connecting rod is articulated with the middle part of the crank shaft, and a second end of the connecting rod is articulated with a first end of the piston rod, and a second end of the piston rod is connected with the main shaft through the bearing assembly; and
the bearing assembly comprises a sliding flat key, an inner sleeve, a lock nut, a plug, a second bearing and an outer sleeve; the outer sleeve is connected with the motor shell; the inner sleeve is mounted in a hole of the outer sleeve through the sliding flat key, and the second bearing is configured to support the inner sleeve on the main shaft; the lock nut is mounted on the main shaft, and is configured to clamp an inner ring of the second bearing; the plug is in threaded connection with an end of the inner sleeve facing towards the piston rod, and is configured to clamp an outer ring of the second bearing; and the plug is connected with the piston rod.

In an embodiment, the oscillation converting assembly comprises a sliding block, a drive pin, an oil-free boss pad and a flanged self-lubricating device;
wherein each side of a portion of the main shaft extending into the second hub is provided with a slideway, and the slideway is perpendicular to the axis of the main shaft; the sliding block is provided in the slideway; each of the plurality of second blade bases is provided with a pin hole, and the drive pin is in clearance fit with the pin hole; the oil-free boss pad is provided in the slideway, and is located between the slideway and the sliding block; and the flanged self-lubricating device is provided on a stepped surface on a side of each of the plurality of second blade bases.

In an embodiment, the counter-rotating blade-type underwater low-frequency sound-emitting device further comprises a support frame and a first sealing sleeve; the first driving assembly, the second driving assembly and the first sealing sleeve are provided on the support frame; and the first sealing sleeve is internally provided with a plurality of third bearings, and the plurality of third bearings are configured to support the hub shaft.

In an embodiment, the counter-rotating blade-type underwater low-frequency sound-emitting device further comprises a crankcase; two ends of the crank shaft are respectively mounted on two side walls of the crankcase perpendicular to the output shaft of the second motor through a fourth bearing; a side wall of the crankcase facing towards the main shaft is provided with a guide hole, and the guide hole is in clearance fit with the piston rod; a second sealing sleeve is mounted on an outer wall of the crankcase at a position where the guide hole is located; and the second sealing sleeve is sleevedly provided on the piston rod.

Compared to the prior art, the present disclosure has the following beneficial effects.
(1) The present disclosure has the simple structure and reliable functions, and has significant advantages in low-frequency high-power transmission. Compared to a single-stage propeller, the present disclosure has a higher efficiency and an advantage of torque balancing.
(2) The rotating motion and the reciprocation do not interfere with each other. The speeds of the first motor and the second motor can be respectively controlled to independently adjust the counter-rotating motion parameters and the reciprocating blade oscillation parameters to modulate low-frequency acoustic wave with different characteristics.
(3) The counter-rotating blade assembly of the present disclosure is convenient for assembly and disassembly. The counter-rotating blade assembly can also be replaced with the first blade and the second blade with different shapes and quantities to study its influence on modulating the low-frequency acoustic wave. In addition, it only needs one motor to realize positive and reverse rotation of the primary blade assembly and the secondary blade assembly.

### BRIEF DESCRIPTION OF THE DRAWINGS

FIG. 1 is an overall structural diagram of counter-rotating blade-type underwater low-frequency sound-emitting device according to an embodiment of the present disclosure.

FIG. 2 is a mounting diagram of a counter-rotating blade assembly according to an embodiment of the present disclosure.

FIG. 3 is a sectional view of the counter-rotating blade assembly in FIG. 2 along an A-A line.

FIG. 4 is a structure diagram of a counter-rotating conversion assembly according to an embodiment of the present disclosure.

FIG. 5 is a structure diagram of an interior of a crankcase according to an embodiment of the present disclosure.

FIG. 6 is a structure diagram of an oscillation converting assembly in a hub of a secondary blade assembly according to an embodiment of the present disclosure.

FIG. 7 is a structure diagram of the hub of the secondary blade assembly according to an embodiment of the present disclosure.

FIG. 8 is a structure diagram of a blade base of the secondary blade assembly according to an embodiment of the present disclosure.

In the figures: primary blade assembly 1; counter-rotating conversion assembly 2; secondary blade assembly 3; first driving assembly 4; second driving assembly 5; oscillation converting assembly 6; support frame 7;
hub shaft 1.1; first hub 1.2; first blade 1.3; first blade base 1.4; first bearing 1.5; first sealing sleeve 1.6; second flange 1.7;
first gear 2.1; gear ring 2.2; connecting plate 2.3; second gear 2.4;
second blade 3.1; second blade base 3.2; front end cover 3.4; second hub 3.5;
first flange 4.1; rotor 4.2; stator 4.3; motor shell 4.4; motor shaft 4.5;
second motor 5.1; compensator 5.3; crankcase 5.4; second sealing sleeve 5.5; third flange 5.6; crank shaft 5.4.1; balance block 5.4.2; connecting rod 5.4.3; piston rod 5.4.4; bolt 5.4.5;
sliding block 6.1; drive pin 6.2; oil-free boss pad 6.3; flanged self-lubricating device 6.4; main shaft 6.5;
sliding flat key 6.6; inner sleeve 6.7; lock nut 6.8; plug 6.9; and outer sleeve 6.10.

### DETAILED DESCRIPTION OF EMBODIMENTS

The present disclosure will be further described below with reference to the accompanying drawings and embodiments.

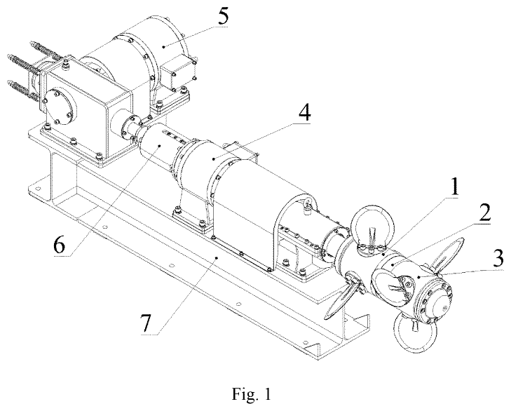

Referring to FIG. 1, a counter-rotating blade-type underwater low-frequency sound-emitting device includes a counter-rotating blade assembly, a first driving assembly 4, a second driving assembly 5, a oscillation converting assembly 6 and a support frame 7.

The counter-rotating blade assembly includes a primary blade assembly 1, a counter-rotating conversion assembly 2 and a secondary blade assembly 3. The counter-rotating blade assembly is a moving acoustic component. The primary blade assembly 1 is configured to drive the secondary blade assembly 3 to rotate through the counter-rotating conversion assembly 2. A rotating direction of the secondary blade assembly 3 is opposite to that of the primary blade assembly 1. The primary blade assembly 1 includes a plurality of first blades 1.3. The second blade assembly 3 includes a plurality of second blades 3.1. The plurality of second blades 3.1 are configured to perform periodic oscillation around their own axis at a natural frequency to realize acceleration and speed modulation of a water flow, so as to generate a low-frequency acoustic wave.

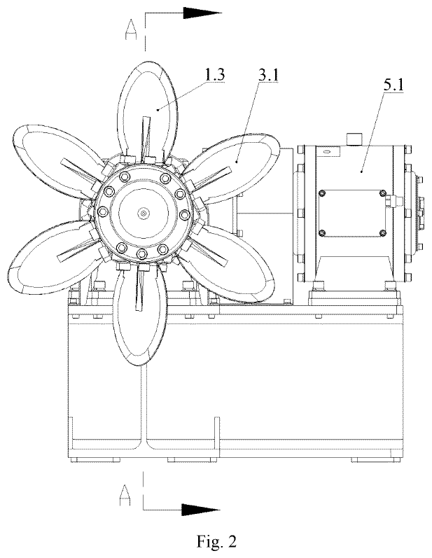

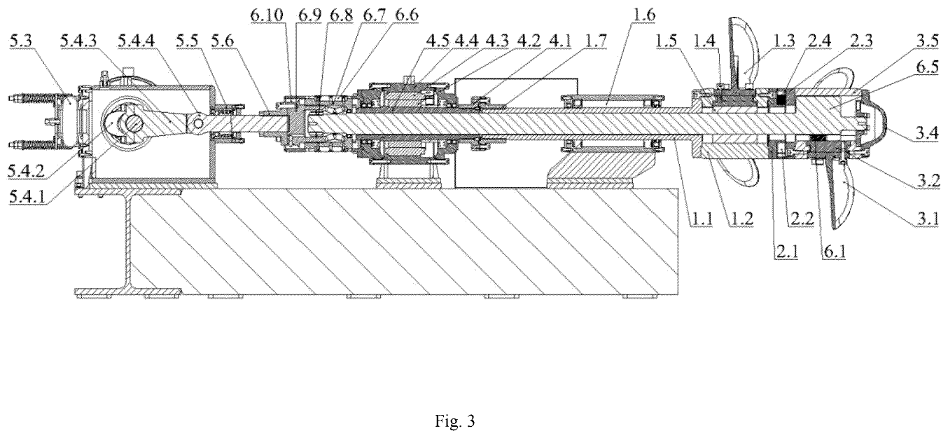

Referring to FIGS. 2-3, the secondary blade assembly 3 is coaxial with the primary blade assembly 1, and mounting angles of the plurality of first blades 1.3 are opposite to that of the plurality of second blades 3.1 of the secondary blade assembly 3.

The primary blade assembly 1 includes three first blades 1.3, three first blade bases 1.4, a first hub 1.2, a hub shaft 1.1 and a first bearing 1.5. A first end of the first hub 1.2 is connected with the hub shaft 1.1, and a second end of the first hub 1.2 is connected with the counter-rotating conversion assembly 2. The hub shaft 1.1 has a tubular structure. The hub shaft 1.1 is sleevedly provided on the main shaft 6.5, and is in clearance fit with the main shaft 6.5. The hub shaft 1.1 is connected with the first driving assembly. The first hub 1.2 has a first cylindrical structure with a center hole. The center hole of the first hub 1.2 has a triangular structure (the number of sides of the cross section of the center hole of the first hub 1.2 is a multiple of the number of the plurality of first blades 1.3; if the number of the plurality of first blades 1.3 is 2, the cross section of the center hole of the first hub 1.2 has a square structure; and if the number of the plurality of first blades 1.3 is >2, the number of sides of the cross section of the center hole of the first hub 1.2 is equal to the number of the plurality of first blades 1.3). The first bearing 1.5 is a sliding bearing, and is in transition fit with to the center hole of the first hub 1.2. The first bearing 1.5 is supported on the main shaft 6.5. Each side of the center hole of the first hub 1.2 is provided with a first base hole, and the first base hole is a cylindrical stepped hole with a round cross section, and a diameter of an end of the first base hole close to the plurality of first blades 1.3 is smaller than that of an end of the first base hole away from the plurality of first blades 1.3. Each of the three first blade bases 1.4 has a stepped shaft structure, and the first base hole is in clearance fit with a corresponding one among the plurality of first blade bases 1.4. The three first blades 1.3 are fixedly provided on an outer end surface of each of the three first blade bases 1.4.

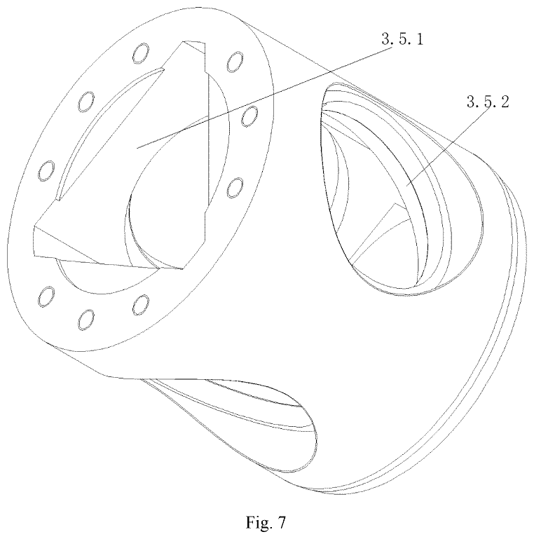

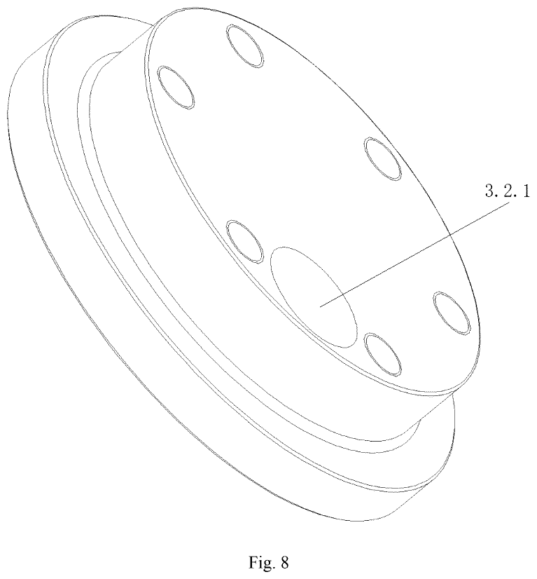

Referring to FIGS. 3, 7-8, the secondary blade assembly 3 includes three second blades 3.1, three second blade bases 3.2, a second hub 3.5 and a front end cover 3.4. A mounting structure of the three first blades 1.3 of the primary blade assembly 1 on the first hub 1.2 is similar to that of the three second blades 3.1 of the secondary blade assembly 3 on the second hub 3.5. A first end of the second hub 3.5 is connected with the counter-rotating conversion assembly 2, and a second end of the second hub 3.5 is connected with the front end cover 3.4. The second hub 3.5 has a cylindrical structure with a center hole 3.5.1. A cross section of the center hole of the second hub 3.5 has a triangular structure (the number of sides of the cross section of the center hole of the second hub 3.5 is a multiple of the number of a plurality of second blades 3.1; if the number of the plurality of second blades 3.1 is 2, the cross section of the center hole of the second hub 3.5 has a square structure; and if the number of the plurality of second blades 3.1 is >2, the number of sides of the cross section of the center hole of the second hub 3.5 is equal to the number of the plurality of second blades 3.1). Each side of the center hole of the second hub 3.5 is provided with a second base hole 3.5.2, and the second base hole 3.5.2 is a cylindrical stepped hole with a round cross section, and a diameter of an end of the second base hole 3.5.2 close to the plurality of second blades 3.1 is smaller than that of an end of the second base hole 3.5.2 away from the plurality of second blades 3.1. Each of the three second blade bases 3.2 has a stepped shaft structure, and the second base hole 3.5.2 is in clearance fit with the three second blade bases 3.2, respectively. Each of the three second blades 3.1 is fixedly provided on an outer end surface of each of the three second blade bases 3.2 in one-to-one correspondence. The second hub 3.5 is provided on an end of the main shaft 6.5, and the main shaft 6.5 is in clearance fit with the center hole 3.5.1 of the second hub 3.5, and the main shaft 6.5 is configured to slide relative to the center hole 3.5.1 of the second hub 3.5.

The three first blades 1.3 are fixed on the three first blade bases 1.4 in one-to-one correspondence, and can be replaced with blades with different shapes. The three second blades 3.1 are fixed on the three second blade bases 3.2 in one-to-one correspondence, and can be replaced with blades with different shapes. The first hub 1.2 and the second hub 3.5 can be detachably mounted, which is convenient to replace hubs with different numbers of center holes.

The first driving assembly 4 and the second driving assembly 5 are driven by motors. The first driving assembly 4 is configured to realize rotation motion of the counter-rotating blade assembly. The second driving assembly 5 and the oscillation converting assembly 6 are configured to realize consistent and periodic reciprocation of all of the three second blades 3.1 of the secondary blade assembly 3. The first driving assembly 4 and the second driving assembly 5 are fixedly provided on the support frame 7. The support frame 7 is configured to support the counter-rotating blade-type underwater low-frequency sound-emitting device, and ensure axes of the primary blade assembly 1, the counter-rotating conversion assembly 2, the secondary blade assembly 3, the first driving assembly 4, the second driving assembly 5 and the oscillation converting assembly 6 are at the same level.

Referring to FIG. 3, the first driving assembly 4 includes a first flange 4.1, a rotor 4.2, a stator 4.3, a motor shell 4.4 and a motor shaft 4.5. The stator 4.3 is fixedly provided on an inner wall of the motor shell 4.4. The rotor 4.2 is fixedly connected with the motor shaft 4.5, and is configured to drive the motor shaft 4.5 to rotate. The motor shaft 4.5 has a tubular structure, and is sleevedly provided on the main shaft 6.5, and is in clearance fit with the main shaft 6.5. An end of the motor shaft 4.5 is provided with the first flange 4.1, and the first flange 4.1 is connected with a second flange 1.7 provided at an end of the hub shaft 1.1 through a first bolt, so as to drive the hub shaft 1.1 to rotate. The hub shaft 1.1 is configured to drive the first hub 1.2 to rotate through a second bolt, so as to drive the primary blade assembly 1 to rotate.

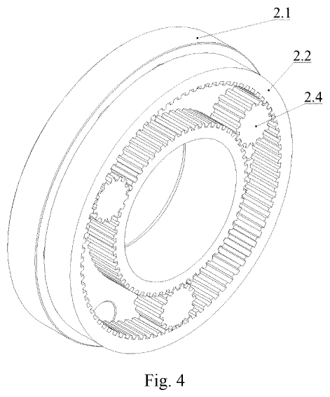

Referring to FIGS. 3-4, the counter-rotating conversion assembly 2 includes a first gear 2.1, a gear ring 2.2, a connecting plate 2.3 and a second gear 2.4. The first gear 2.1 includes a connecting part and a gear part, and the connecting part and the gear part are coaxially provided, and an end of the connecting part is coaxially connected with the first hub 1.2. The gear part engages with three second gears 2.4, and the three second gears 2.4 engage with the gear ring 2.2. The ear part and the three second gears 2.4 are provided in the gear ring 2.2, and the three second gears 2.4 are provided between the gear part and the gear ring 2.2. The connecting plate 2.3 is fixedly provided at an end of the gear ring 2.2 towards the secondary blade assembly, and is connected with the second hub 3.5.

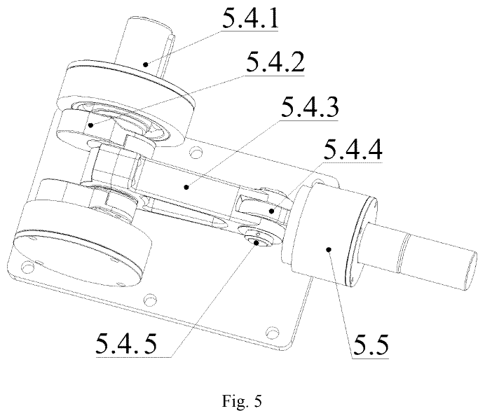

Referring to FIGS. 3-5, the second driving assembly 5 includes a second motor 5.1, a coupling, a compensator 5.3, a crankcase 5.4, a second sealing sleeve 5.5 and a third flange 5.6. The crankcase 5.4 is internally provided with a crank shaft 5.4.1, a balance block 5.4.2, a connecting rod 5.4.3 and a piston rod 5.4.4. The balance block 5.4.2 is mounted on the crank shaft 5.4.1. Two ends of the crank shaft 5.4.1 are coaxially, and are mounted on two side walls of crankcase 5.4 that parallel to an output shaft of the second motor 5.1 through a fourth bearing. A side wall of the crankcase 5.4 towards the main shaft 6.5 is provided with a guide hole, and the guide hole is in clearance fit with the piston rod 5.4.4. The second sealing sleeve 5.5 is mounted at a position of the guide hole on an outer wall of the crankcase 5.4. The second sealing sleeve 5.5 is sleevedly provided on the piston rod 5.4.4.

The output shaft of the second motor 5.1 is perpendicular to an axis of the main shaft 6.5, and is coaxially connected with an end of the crank shaft 5.4.1 through the coupling. An axis of a middle part of the crank shaft 5.4.1 is parallel to the output shaft of the second motor 5.1. A first end of the connecting rod 5.4.3 is articulated with the middle part of the crank shaft 5.4.1, and a second end of the connecting rod 5.4.3 is articulated with a first end of the connecting rod 5.4.3 is articulated with the, and a second end of the connecting rod 5.4.3 is connected with a bearing assembly through the third flange 5.6. The bearing assembly is connected with the main shaft 6.5.

The bearing assembly includes a sliding flat key 6.6, an inner sleeve 6.7, a lock nut 6.8, a plug 6.9, a second bearing and an outer sleeve 6.10. A first end of the main shaft 6.5 is provided in the second hub 3.5, and a second end of the main shaft 6.5 is provided at an interior of the bearing assembly. The main shaft 6.5 is configured to pass through the counter-rotating conversion assembly 2, the primary blade assembly 1 and the first driving assembly 4.

The outer sleeve 6.10 is connected with the motor shell 4.4, and is fixed. The inner sleeve 6.7 is connected with the outer sleeve 6.10 through the sliding flat key 6.6, and the sliding flat key 6.6 is configured to limit the motion of the inner sleeve 6.7. The plug 6.9 is mounted on the main shaft 6.5, and is configured to clamp an inner ring of the second bearing. The plug 6.9 is in threaded connection with an end of the inner sleeve 6.7 towards the piston rod, and is configured to clamp an outer ring of the second bearing to realize axial limitation of the second bearing. The plug 6.9 is in threaded connection with the third flange 5.6 through a third bolt, so as to convert a linear reciprocation of the piston rod 5.4.4 to a linear reciprocation of main shaft 6.5.

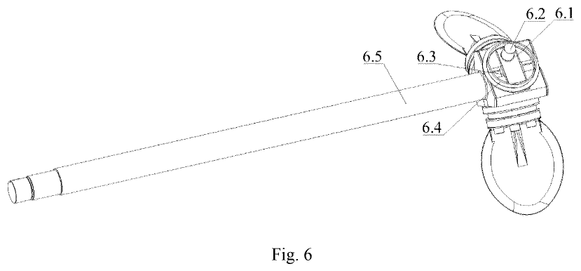

Referring to FIGS. 3, 6-8, the oscillation converting assembly 6 includes a sliding block 6.1, a drive pin 6.2, an oil-free boss pad 6.3 and a flanged self-lubricating device 6.4. A slideway is provided on each side of the main shaft 6.5 extending into second hub 3.5, and the slideway is perpendicular to the axis of the main shaft 6.5. The slideway corresponding to each one of the three second blade bases 3.2 is provided with the sliding block 6.1. The drive pin 6.2 is provided on the sliding block 6.1. The drive pin 6.2 is in clearance fit with a pin hole 3.2.1 of each one of the three second blade bases 3.2. An axis of the pin hole 3.2.1 is parallel to but not coaxial with that of each one of the three second blade bases 3.2. The flanged self-lubricating device 6.4 is provided in the slideway, and is located between the slideway and the sliding block 6.1. The flanged self-lubricating device 6.4 is provided on a step surface on a side of each one of the three second blade bases 3.2.

Owing to a lubrication effect of the oil-free boss pad 6.3 and the flanged self-lubricating device 6.4, the sliding block 6.1 is configured to move along an axial direction of the main shaft 6.5 and slide relative to the main shaft 6.5, that is, the drive pin 6.2 is configured to drive the three second blade bases 3.2 to rotate, so as to convert a linear reciprocation of main shaft 6.5 into consistent reciprocation of all of the three second blades 3.1 of the secondary blade assembly 3.

The counter-rotating blade-type underwater low-frequency sound-emitting device further includes a first sealing sleeve 1.6. The first sealing sleeve 1.6 is mounted on the support frame 7. Each of two ends of the first sealing sleeve 1.6 is provided with a third bearing. A first sealing ring is provided between the third bearing and an end cover of the first sealing sleeve 1.6. Two third bearings are configured to support the hub shaft 1.1. A second sealing ring is provided between the inner sleeve 6.7 of the second bearing and the second bearing. A third sealing ring is provided in the second sealing sleeve 5.5 at a front end of the crankcase 5.4.

What is claimed is:

1. A counter-rotating blade-type underwater low-frequency sound-emitting device, comprising:
a counter-rotating blade assembly;
a first driving assembly;
a second driving assembly; and
an oscillation converting assembly;
wherein the counter-rotating blade assembly comprises a main shaft, a primary blade assembly, a hub shaft, a secondary blade assembly and a counter-rotating conversion assembly; the primary blade assembly is mounted on the main shaft through a first bearing, and comprises a plurality of first blades; the secondary blade assembly is mounted on the main shaft, and comprises a plurality of second blades; the hub shaft is sleevedly provided on the main shaft; a first end of the primary blade assembly is connected with the hub shaft, and a second end of the primary blade assembly is connected with the secondary blade assembly through the counter-rotating conversion assembly; and a rotating direction of the secondary blade assembly is opposite to that of the primary blade assembly;
the first driving assembly is configured to drive the hub shaft to rotate; and
the second driving assembly is configured to drive the main shaft to perform linear reciprocation; and the oscillation converting assembly is configured to covert the linear reciprocation of the main shaft into periodic reciprocating oscillation of the plurality of second blades.

2. The sound-emitting device of claim 1, wherein the primary blade assembly further comprises a plurality of first blade bases and a first hub; a first end of the first hub is connected with the hub shaft, and a second end of the first hub is connected with the counter-rotating conversion assembly; the hub shaft has a tubular structure; and the hub shaft is connected with the first driving assembly; and
the first hub has a cylindrical structure with a center hole; the center hole of the first hub has a first polygonal cross section, and the number of sides of the first polygonal cross section is an integer multiple of the number of the plurality of first blades; the first bearing has a sliding bearing structure, and the first bearing is in transition fit with the center hole of the first hub; each side of the center hole of the first hub is provided with a first base hole; the first base hole is a cylindrical stepped hole with a round cross section, and a diameter of an end of the first base hole close to the plurality of first blades is smaller than that of an end of the first base hole away from the plurality of first blades; each of the plurality of first blade bases has a stepped shaft structure, and the first base hole is in clearance fit with a corresponding one among the plurality of first blade bases; and the plurality of first blades are fixedly provided on outer end surfaces of the plurality of first blade bases, respectively.

3. The sound-emitting device of claim 2, wherein the secondary blade assembly further comprises a plurality of second blade bases, a second hub and a front end cover; a first end of the second hub is connected with the counter-rotating conversion assembly, and a second end of the second hub is connected with the front end cover; the secondary blade assembly and the primary blade assembly are coaxial, and have opposite blade mounting angles; and
the second hub has a cylindrical structure with a center hole; the center hole of the second hub has a second polygonal cross section, and the number of sides of the second polygonal cross section is a multiple of the number of the plurality of second blades; each side of the center hole of the second hub is provided with a second base hole; the second base hole is a cylindrical stepped hole with a round cross section, and a diameter of an end of the second base hole close to the plurality of second blades is smaller than that of an end of the second base hole away from the plurality of second blades; each of the plurality of second blade bases has a stepped shaft structure, and the second base hole is in clearance fit with a corresponding one among the plurality of second blade bases; the plurality of second blades are fixedly provided on outer end surfaces of the plurality of second blade bases, respectively; and the second hub is provided on an end of the main shaft, and the main shaft is in clearance fit with the center hole of the second hub.

4. The sound-emitting device of claim 3, wherein the counter-rotating conversion assembly comprises a first gear, a plurality of second gears, a gear ring and a connecting plate; the first gear comprises a connecting part and a gear part, and the connecting part and the gear part are coaxially provided; an end of the connecting part is coaxially connected with the first hub; the gear part engages with the plurality of second gears, and the plurality of second gears engage with the gear ring; the gear part and the plurality of second gears are provided in the gear ring, and the plurality of second gears are provided between the gear part and the gear ring; and the connecting plate is fixedly provided at an end of the gear ring adjacent to the secondary blade assembly, and is connected with the second hub.

5. The sound-emitting device of claim 4, wherein the first driving assembly comprises a first motor, a motor shaft and a motor shell; a stator of the first motor is fixedly provided on an inner wall of the motor shell; a rotor of the first motor is fixedly connected with the motor shaft; the motor shaft has a tubular structure; an end of the motor shaft adjacent to the counter-rotating blade assembly is provided with a first flange; the hub shaft is provided with a second flange; and the first flange is connected with the second flange to drive the counter-rotating blade assembly to rotate.

6. The sound-emitting device of claim 5, wherein the second driving assembly comprises a second motor, a coupling, a crank shaft, a connecting rod, a piston rod and a bearing assembly; an output shaft of the second motor is perpendicular to the axis of the main shaft, and is coaxially connected with an end of the crank shaft through the coupling; two ends of the crank shaft are coaxial, and an axis of a middle part of the crank shaft is parallel to the output shaft of the second motor; a first end of the connecting rod is articulated with the middle part of the crank shaft, and a second end of the connecting rod is articulated with a first end of the piston rod; and a second end of the piston rod is connected with the main shaft through the bearing assembly; and
the bearing assembly comprises a sliding flat key, an inner sleeve, a lock nut, a plug, a second bearing and an outer sleeve; the outer sleeve is connected with the motor shell; the inner sleeve is mounted in a hole of the outer sleeve through the sliding flat key, and the second bearing is configured to support the inner sleeve on the main shaft; the lock nut is mounted on the main shaft, and is configured to clamp an inner ring of the second bearing; the plug is in threaded connection with an end of the inner sleeve facing towards the piston rod, and is configured to clamp an outer ring of the second bearing; and the plug is connected with the piston rod.

7. The sound-emitting device of claim 6, wherein the oscillation converting assembly comprises a sliding block, a drive pin, an oil-free boss pad and a flanged self-lubricating device; and
each side of a portion of the main shaft extending into the second hub is provided with a slideway, and the slideway is perpendicular to the axis of the main shaft; the sliding block is provided in the slideway; the drive pin is provided on the sliding block; each of the plurality of second blade bases is provided with a pin hole, and the drive pin is in clearance fit with the pin hole; the oil-free boss pad is provided in the slideway, and is located between the slideway and the sliding block; and the flanged self-lubricating device is provided on a stepped surface on a side of each of the plurality of second blade bases.

8. The sound-emitting device of claim 1, further comprising:
a support frame and a sealing sleeve;
wherein the first driving assembly, the second driving assembly and the sealing sleeve are provided on the support frame; and the sealing sleeve is internally provided with a plurality of second bearings, and the plurality of second bearings are configured to support the hub shaft.

9. The sound-emitting device of claim 6, further comprising:
a crankcase;
wherein two ends of the crank shaft are respectively mounted on two side walls of the crankcase perpendicular to the output shaft of the second motor through a third bearing; a side wall of the crankcase facing towards the main shaft is provided with a guide hole, and the guide hole is in clearance fit with the piston rod; a sealing sleeve is mounted on an outer wall of the crankcase at a position where the guide hole is located; and the sealing sleeve is sleeved on the piston rod.
